(19) United States
(12) Patent Application Publication
(10) Pub. No.: US 2026/0157390 A1
(43) Pub. Date: Jun. 11, 2026

(54) SEPARATOR DRUM WITH SIDE SURFACES DEFINING AT LEAST ONE FIRST PEAK, SYSTEM, AND METHOD OF USING SYSTEM, THEREOF

(71) Applicant: Altria Client Services LLC, Richmond, VA (US)

(72) Inventor: Dwight D. WILLIAMS, Powhatan, VA (US)

(73) Assignee: Altria Client Services LLC, Richmond, VA (US)

(21) Appl. No.: 19/408,908

(22) Filed: Dec. 4, 2025

Related U.S. Application Data
(60) Provisional application No. 63/729,050, filed on Dec. 6, 2024.

(51) Int. Cl. A23G 4/04

(52) U.S. Cl. CPC A23G 4/04

(57) ABSTRACT

The separator drum includes a major body, the major body being cylindrical in shape with a first end and a second end, the major body having side surfaces that span a longitudinal length of the major body between the first end and the second end, a longitudinal centerline of the major body running through a center of a vertical cross-section of the major body, at least one first portion of the side surfaces defining at least one first ridge with at least one first peak, at least one second portion of a remainder of the side surfaces, defining an embossing design, the at least one first peak extending to, or being configured to extend to, a first radial distance from the longitudinal centerline, the first radial distance being larger than a respective radial distance from the longitudinal centerline for an outer surface of the remainder of the side surfaces.

### CROSS-REFERENCE TO RELATED APPLICATION

This application claims the priority benefit of U.S. Provisional Application No. 63/729,050, filed on Dec. 6, 2024, the entire contents of which are incorporated herein by reference in their entirety.

### BACKGROUND

### Field

Example embodiments generally relate to a separator drum.

### Description of Related Art

Manufacturing processes can use drums to score consumer products.

### SUMMARY

At least one example embodiment is directed toward a separator drum.

In at least one example embodiment, the separator drum includes a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end, at least one first portion of the side surfaces defining at least one first ridge with at least one first peak that extends along at least part of the longitudinal length of the major body, at least one second portion of a remainder of the side surfaces, other than the at least one first portion, defining an embossing design, the at least one first peak extending to, or being configured to extend to, a first radial distance from the longitudinal centerline, the first radial distance being larger than a respective radial distance from the longitudinal centerline for an outer surface of the remainder of the side surfaces.

In at least one example embodiment, the first radial distance is a maximal radial distance from the longitudinal centerline relative to the outer surface of the remainder of the side surfaces.

In at least one example embodiment, the at least one first peak extends continuously along the longitudinal length of the major body from the first end to the second end.

In at least one example embodiment, the at least one first peak includes a sharp distal edge for cutting and separating at least one material used to make at least one consumer product.

In at least one example embodiment, the at least one material includes an insoluble gum base for making chewing gum.

In at least one example embodiment, the at least one first peak is a sharp edge for cutting and separating at least one material used to make at least one consumer product.

In at least one example embodiment, the major body defines an aperture running through a center of the major body from the first end to the second end of the major body.

In at least one example embodiment, the longitudinal centerline runs through a center of a vertical cross-section of the aperture from the first end to the second end of the major body.

In at least one example embodiment, the aperture has a circular vertical cross-section from the first end to the second end of the major body, and the longitudinal centerline runs through a center of the circular vertical cross-section.

In at least one example embodiment, the aperture has a substantially circular vertical cross-section from the first end to the second end of the major body, and a groove is defined along a portion of a periphery of the aperture from the first end to the second end.

In at least one example embodiment, the groove has a vertical cross-section that is in the shape of a square or a rectangle.

In at least one example embodiment, the at least one first peak and the longitudinal centerline are parallel to each other.

In at least one example embodiment, the embossing design includes ridges that extend along at least part of the longitudinal length of the major body from the first end to the second end.

In at least one example embodiment, the ridges are positioned equidistantly around a periphery of the side surfaces of the major body.

In at least one example embodiment, each of the ridges defines a peak that is parallel to the at least one first peak.

In at least one example embodiment, the embossing design includes a repeating pattern.

In at least one example embodiment, the repeating pattern includes raised shapes, symbols, letters, or indicia that are defined by the at least one second portion of the remainder of the side surfaces.

In at least one example embodiment, the at least one first peak includes a first peak and a second peak that extend along at least part of the longitudinal length of the major body from the first end to the second end.

In at least one example embodiment, the first peak and the second peak extend to, or are configured to extend to, the first radial distance from the longitudinal centerline.

In at least one example embodiment, the first peak and the second peak are parallel to each other.

In at least one example embodiment, the at least one first peak includes multiple peaks that extend to, or are configured to extend to, the first radial distance from the longitudinal centerline, the multiple peaks being parallel to each other.

In at least one example embodiment, the multiple peaks are positioned equidistantly around a periphery of the side surfaces of the major body.

In at least one example embodiment, the first end and the second end oppose each other on the separator drum.

In at least one example embodiment, the first end and the second end are both flat surfaces.

In at least one example embodiment, the separator drum further includes an actuator embedded within the major body, the actuator being configured to move the at least one first ridge between a first position and a second position in a direction that is radial to the longitudinal centerline.

In at least one example embodiment, the first position extends the at least one first peak to the first radial distance and the second position retracts the at least one first peak to be a second radial distance from the longitudinal centerline, the first radial distance being larger than the second radial distance.

In at least one example embodiment, the actuator includes at least one of a hydraulic actuator, a pneumatic actuator, a piezoelectric actuator, a thermal expansion actuator, or a magnetic actuator.

In at least one example embodiment, the actuator includes a controller and a wireless interface, and the controller is configured to send and receive control and information signals via the wireless interface to respectively provide confirmation that the at least one first ridge is in the first position or the second position and receive commands that allow the actuator to be controlled from a remote location.

At least another example embodiments is directed toward a system.

In at least one example embodiment, the system includes at least one conveyor configured to convey a material in a first direction; and a separator drum and a roller that interface with each other at a break point of the at least one conveyor, the roller and the separator drum being respectively below and above the break point, the roller having a smooth outer surface that is able to receive a first portion of the material and continue to convey the first portion across the break point and back onto the at least one conveyor, the separator drum including a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end, at least one first portion of the side surfaces defining at least one first ridge with at least one first peak that extends along at least part of the longitudinal length of the major body, at least one second portion of a remainder of the side surfaces, other than the at least one first portion, defining an embossing design, the at least one first peak extending to, or being configured to extend to, a first radial distance from the longitudinal centerline, the first radial distance being larger than a respective radial distance from the longitudinal centerline for an outer surface of the remainder of the side surfaces.

In at least one example embodiment, the separator drum and the roller are configured to rotate in opposite directions.

In at least one example embodiment, the outer surface of the remainder of the side surfaces of the separator drum is less than or equal to a second radial distance from the longitudinal centerline, the first radial distance being larger than the second radial distance.

In at least one example embodiment, the at least one first peak of the separator drum extends continuously along the longitudinal length of the major body from the first end to the second end.

In at least one example embodiment, the at least one first peak includes a sharp distal edge for cutting and separating the first portion of the material that is on the outer surface of the roller, when the at least one first peak is within a separating proximity of an upper-most surface of the roller.

In at least one example embodiment, a thickness of the first portion of the material is in a first range of 1 mm to 10 mm, and the separating proximity is in a second range of 0 mm to 5 mm.

In at least one example embodiment, a thickness of the first portion of the material is 8 mm, and the separating proximity is in a range of 0.5 mm to 1 mm.

In at least one example embodiment, the material includes an insoluble gum base for making chewing gum.

In at least one example embodiment, the insoluble gum base is conveyed along the at least one conveyor as a thin band of the insoluble gum base.

In at least one example embodiment, the at least one first peak of the separator drum is a sharp edge for cutting and separating the first portion of the material that is on the outer surface of the roller.

In at least one example embodiment, the major body defines an aperture running through a center of the major body from the first end to the second end of the major body.

In at least one example embodiment, the longitudinal centerline runs through a center of a vertical cross-section of the aperture from the first end to the second end of the major body.

In at least one example embodiment, the aperture has a circular vertical cross-section from the first end to the second end of the major body, and the longitudinal centerline runs through a center of the circular vertical cross-section.

In at least one example embodiment, the aperture has a substantially circular vertical cross-section from the first end to the second end of the major body, and a groove is defined along a portion of a periphery of the aperture from the first end to the second end.

In at least one example embodiment, the groove has a vertical cross-section that is in the shape of a square or a rectangle.

In at least one example embodiment, the system further includes a drive shaft, an end of the drive shaft being configured to fit within the aperture, a notch of the drive shaft being configured to engage and fit within the groove.

In at least one example embodiment, the system further includes at least one motor, the at least one motor being configured to impart a rotational force on the drive shaft to rotate the separator drum.

In at least one example embodiment, the at least one first peak and the longitudinal centerline of the separator drum are parallel to each other.

In at least one example embodiment, the embossing design of the separator drum includes ridges that extend along at least part of the longitudinal length of the major body from the first end to the second end.

In at least one example embodiment, the ridges are positioned equidistantly around a periphery of the side surfaces of the major body.

In at least one example embodiment, each of the ridges defines a peak that is parallel to the at least one first peak.

In at least one example embodiment, the embossing design of the separator drum include a repeating pattern.

In at least one example embodiment, the repeating pattern includes raised shapes, symbols, letters, or indicia that are defined by the at least one second portion of the remainder of the side surfaces.

In at least one example embodiment, the at least one first peak includes a first peak and a second peak that extend along at least part of the longitudinal length of the major body from the first end to the second end.

In at least one example embodiment, the first peak and the second peak extend to, or are configured to extend to, the first radial distance from the longitudinal centerline.

In at least one example embodiment, the first peak and the second peak are parallel to each other.

In at least one example embodiment, the at least one first peak includes multiple peaks that extend to, or are configured to extend to, the first radial distance from the longitudinal centerline, the multiple peaks being parallel to each other.

In at least one example embodiment, the multiple peaks are positioned equidistantly around a periphery of the side surfaces of the major body.

In at least one example embodiment, the first end and the second end oppose each other on the separator drum.

In at least one example embodiment, the system further includes an actuator embedded within the major body, the actuator being configured to move the at least one first ridge between a first position and a second position in a direction that is radial to the longitudinal centerline.

In at least one example embodiment, the first position extends the at least one first peak to the first radial distance and the second position retracts the at least one first peak to be a second radial distance from the longitudinal centerline, the first radial distance being larger than the second radial distance.

In at least one example embodiment, the system further includes a first proximity switch on the major body and near the at least one first ridge; and a second proximity switch near at least a portion of the break point of the at least one conveyor, the actuator being operationally connected to at least one of the first proximity switch or the second proximity switch in order to move the at least one first ridge to the first position when the first proximity switch and the second proximity switch are proximally close to each other.

In at least one example embodiment, the actuator includes at least one of a hydraulic actuator, a pneumatic actuator, a piezoelectric actuator, a thermal expansion actuator, or a magnetic actuator.

In at least one example embodiment, the system further includes a programmable logic controller configured to communicate with the actuator, wherein the actuator includes a controller and a wireless interface, and the controller is configured to send and receive control and information signals via the wireless interface to respectively provide confirmation to the programmable logic controller that the at least one first ridge is in the first position or the second position and receive commands from the programmable logic controller controls at least some actions of the actuator.

In at least one example embodiment, the system further includes a first proximity switch on the major body and near the at least one first ridge; and a second proximity switch near at least a portion of the break point of the at least one conveyor, the first proximity switch and the second proximity switch being operationally connected to the programmable logic controller, the actuator being operationally connected to the programmable logic controller in order to move the at least one first ridge to the first position when the first proximity switch and the second proximity switch are proximally close to each other.

In at least one example embodiment, the system further includes at least one pair of interfacing rollers, the at least one pair of interfacing rollers being upstream of the separator drum relative to the first direction, the at least one pair of interfacing rollers being configured to press and thin the material into a thin band prior to the material being conveyed to the separator drum.

At least another example embodiment is directed toward a method of making a separator drum.

In at least one example embodiment, the method includes providing a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end; defining at least one first portion of the side surfaces to include at least one first ridge with at least one first peak that extend along at least part of the longitudinal length of the major body; and defining at least one second portion of a remainder of the side surfaces, other than the at least one first portion, to include an embossing design, the at least one first peak extending to, or being configured to extend to, a first radial distance from the longitudinal centerline, the first radial distance being larger than a respective radial distance from the longitudinal centerline for an outer surface of the remainder of the side surfaces.

In at least one example embodiment, the defining defines the at least one second portion such that the outer surface of the remainder of the side surfaces is less than or equal to a second radial distance from the longitudinal centerline, the first radial distance being larger than the second radial distance.

In at least one example embodiment, the defining defines the at least one first portion such that the at least one first peak extends continuously along the longitudinal length of the major body from the first end to the second end.

In at least one example embodiment, the defining defines the at least one first portion such that the at least one first peak includes a sharp distal edge for cutting and separating at least one material used to make at least one consumer product.

In at least one example embodiment, the defining defines the at least one first portion such that the at least one first peak is a sharp edge for cutting and separating at least one material used to make at least one consumer product.

In at least one example embodiment, the method further includes defining an aperture running through a center of the major body from the first end to the second end of the major body.

In at least one example embodiment, the defining defines the aperture such that the longitudinal centerline runs through a center of a vertical cross-section of the aperture from the first end to the second end of the major body.

In at least one example embodiment, the defining defines the aperture to have a circular vertical cross-section from the first end to the second end of the major body, and the longitudinal centerline runs through a center of the circular vertical cross-section.

In at least one example embodiment, the defining defines such that the aperture has a substantially circular vertical cross-section from the first end to the second end of the major body, and a groove is defined along a portion of a periphery of the aperture from the first end to the second end.

In at least one example embodiment, the defining defines the at least one first portion such that the at least one first peak and the longitudinal centerline are parallel to each other.

In at least one example embodiment, the defining defines the at least one second portion such that the embossing design includes ridges that extend along at least part of the longitudinal length of the major body from the first end to the second end.

In at least one example embodiment, the defining defines the at least one second portion such that the ridges are positioned equidistantly around a periphery of the side surfaces of the major body.

In at least one example embodiment, the defining defines the at least one second portion such that the each of the ridges defines a peak that is parallel to the at least one first peak.

In at least one example embodiment, the defining defines the at least one second portion such that the embossing design includes a repeating pattern.

In at least one example embodiment, the defining defines the at least one first portion such that the at least one first peak includes a first peak and a second peak that extend along at least part of the longitudinal length of the major body from the first end to the second end.

In at least one example embodiment, the defining defines the at least one first portion such that the first peak and the second peak extend to, or are configured to extend to, the first radial distance from the longitudinal centerline.

In at least one example embodiment, the defining defines the at least one first portion such that the first peak and the second peak are parallel to each other.

In at least one example embodiment, the providing provides the major body such that the first end and the second end oppose each other on the separator drum.

At least another example embodiment is directed toward a method of making a system.

In at least one example embodiment, the method includes performing the method of making the separator drum; establishing at least one conveyor to convey a material in a first direction; and configuring the separator drum and a roller to interface with each other at a break point of the at least one conveyor, the roller and the separator drum being respectively below and above the break point, the separator drum and the roller being configured to rotate in opposite directions, the roller having a smooth outer surface that is able to receive a first portion of the material and continue to convey the first portion across the break point and back onto the at least one conveyor.

At least another example embodiment is directed toward a method of using a system.

In at least one example embodiment, the method includes conveying a thin band of material in a first direction along at least one conveyor; embossing at least one first portion of the thin band of material at a break point of the at least one conveyor using a separator drum with an embossing design that interfaces with a roller, the roller and the separator drum being respectively below and above the break point, the separator drum and the roller being configured to rotate in opposite directions, the roller having a smooth outer surface that is able to receive the at least one first portion of the thin band and continue to convey the at least one first portion across the break point and back onto the at least one conveyor; and separating part of the at least one first portion using at least one first peak when the at least one first peak is at a separating proximity from an upper-most surface of the roller, the separator drum including a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end, at least one first portion of the side surfaces defining at least one first ridge with the at least one first peak that extends along at least part of a longitudinal length of the major body, at least one second portion of a remainder of the side surfaces, other than the at least one first portion, defining the embossing design, the at least one first peak extending to, or being configured to extend to, a first radial distance from the longitudinal centerline, the first radial distance being larger than a respective radial distance from the longitudinal centerline for an outer surface of the remainder of the side surfaces.

In at least one example embodiment, the embossing embosses using the embossing design of the separator drum.

At least another example embodiment is directed toward a system.

In at least one example embodiment, the system includes at least one conveyor configured to convey a material in a first direction; a separator drum and a roller that interface with each other at a break point of the at least one conveyor, the roller and the separator drum being respectively below and above the break point, the separator drum and the roller being configured to rotate in opposite directions, the roller having a smooth outer surface that is able to receive a first portion of the material and continue to convey the first portion across the break point and back onto the at least one conveyor; and a drive shaft operationally connected to the separator drum to rotate the separator drum, a first longitudinal centerline of the drive shaft being collinear with a second longitudinal centerline of the separator drum, the drive shaft being configured to deflect the separator drum towards the roller to cause at least one first peak of the separator drum to be within a separating proximity of an upper-most surface of the roller to separate part of the first portion at the break point.

In at least one example embodiment, the separator drum includes a major body, the major body being cylindrical in shape with a first end and a second end, the major body having side surfaces that span across a longitudinal length of the major body between the first end and the second end, the second longitudinal centerline of the major body running through a center of a vertical cross-section of the major body from the first end to the second end, at least one first portion of the side surfaces defining at least one first ridge with the at least one first peak, the at least one first peak extending along at least part of the longitudinal length of the major body.

In at least one example embodiment, at least one second portion of a remainder of the side surfaces of the major body, other than the at least one first portion, defining an embossing design.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIGS. 1-4 are illustrations of perspective views of a separator drum, in accordance with at least one example embodiment;

FIGS. 5A and 5B are an illustrations of side views of a separator drum, in accordance with at least one example embodiment;

FIGS. 6A and 6B are illustrations of top views of a separator drum, in accordance with at least one example embodiment;

FIGS. 7A-7C are illustrations of front and back views of a separator drum, in accordance with at least one example embodiment;

FIG. 7D is an illustration of a cross-sectional view of a separator drum that does not include an embossing design, in accordance with at least one example embodiment;

FIGS. 8A-8C are illustrations of cross-sectional views (View VIIIA-VIIIA of FIG. 6 and VIIIB-VIIIB of FIG. 6) of a separator drum, in accordance with at least one example embodiment;

FIG. 8D is an illustration of an exploded view of a portion of FIG. 8C, in accordance with at least one example embodiment;

FIGS. 9A-9C are illustrations of perspective views of a system, in accordance with at least one example embodiment;

FIG. 9D is an illustration of a strut, in accordance with at least one example embodiment;

FIG. 9E is an illustration of a separator drum interfacing with a roller, in accordance with at least one example embodiment;

FIG. 10 is an illustration of consumer products being processed by a separator drum, in accordance with at least one example embodiment;

FIG. 11 is an illustration of a perspective view of a consumer product being processed by a separator drum, in accordance with at least one example embodiment;

FIG. 12A is an illustration of method steps for a method of making a separator drum, in accordance with at least one example embodiment;

FIG. 12B is an illustration of method steps for a method of making a system, in accordance with at least one example embodiment; and

FIG. 12C is an illustration of method steps for a method of using a system, in accordance with at least one example embodiment.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives thereof. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations or sub-combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below,” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

When the words “about” and “substantially” are used in this specification in connection with a numerical value, it is intended that the associated numerical value include a tolerance of ±10% around the stated numerical value, unless otherwise explicitly defined.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

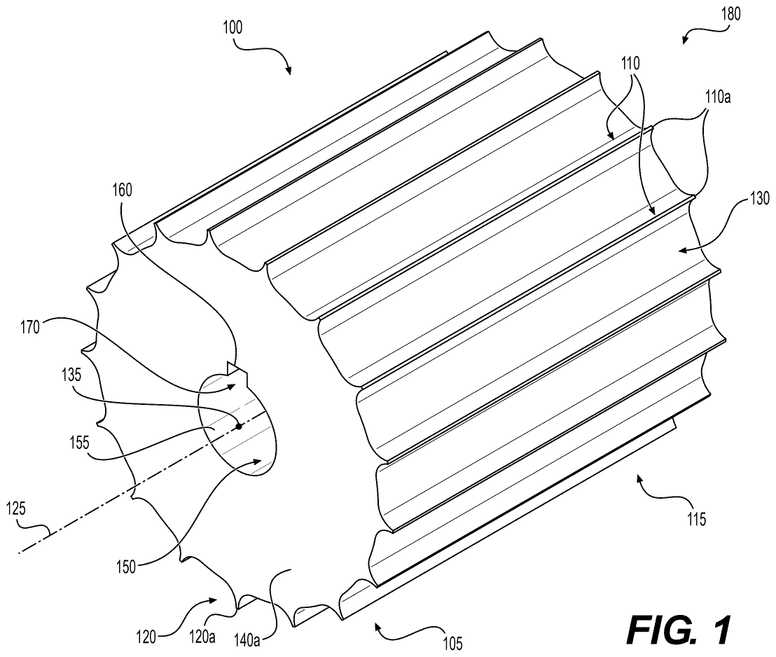

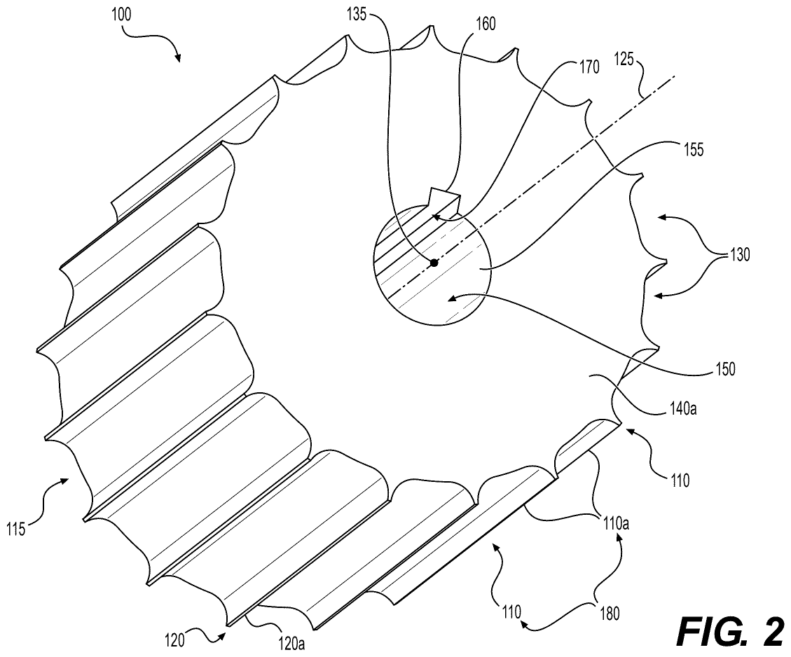

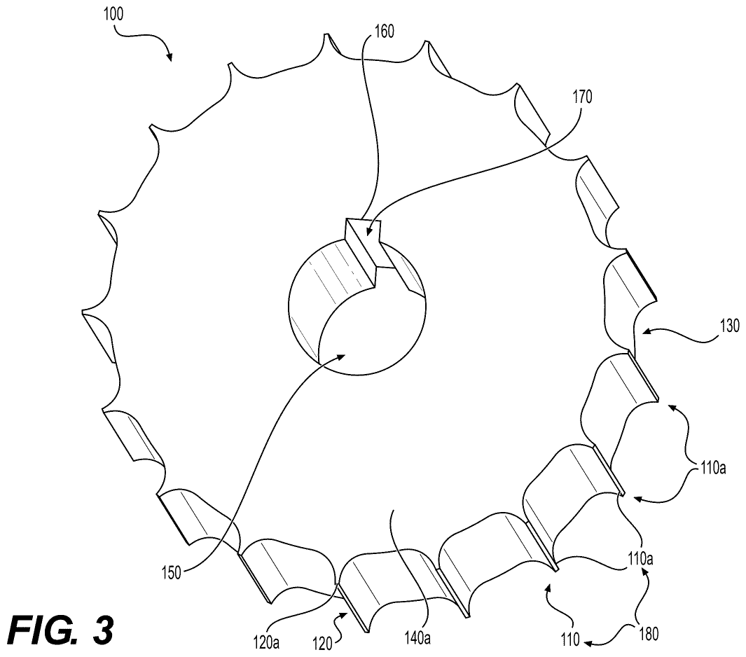

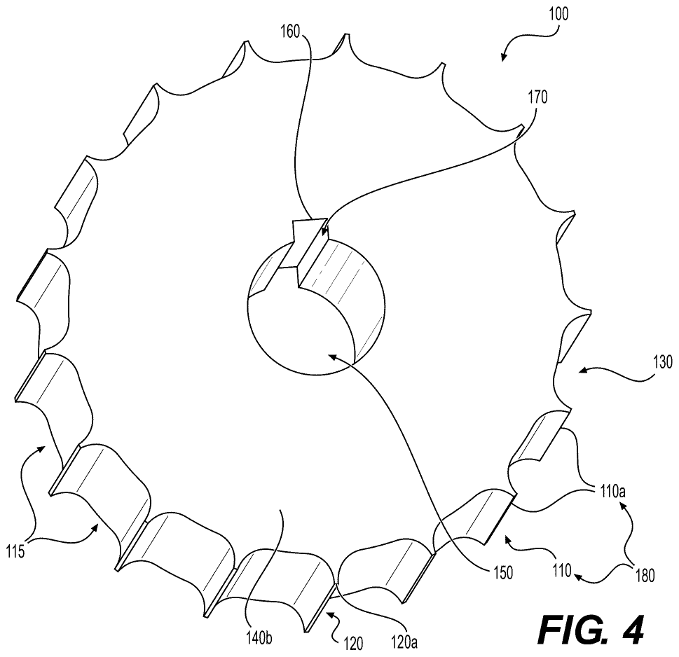

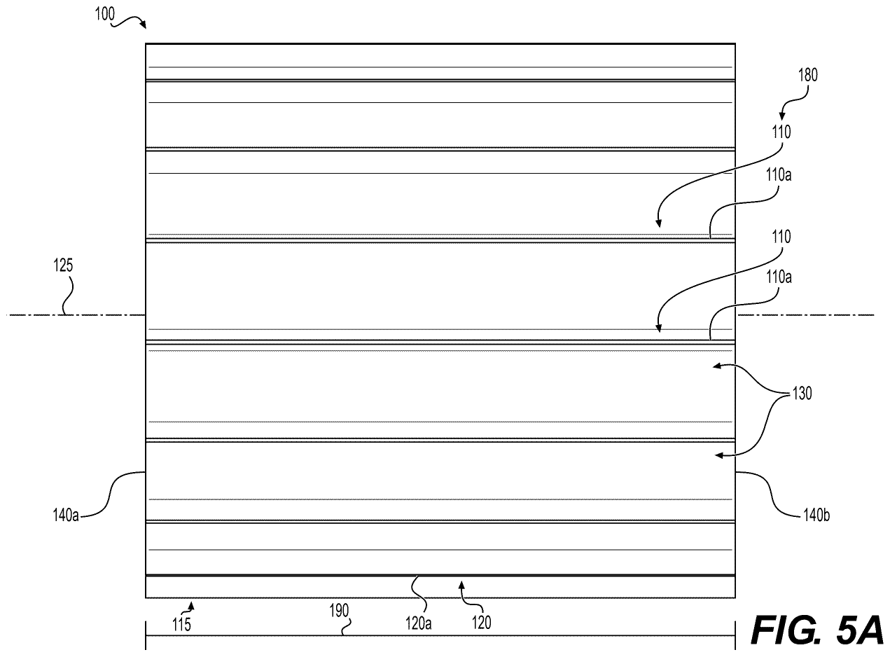

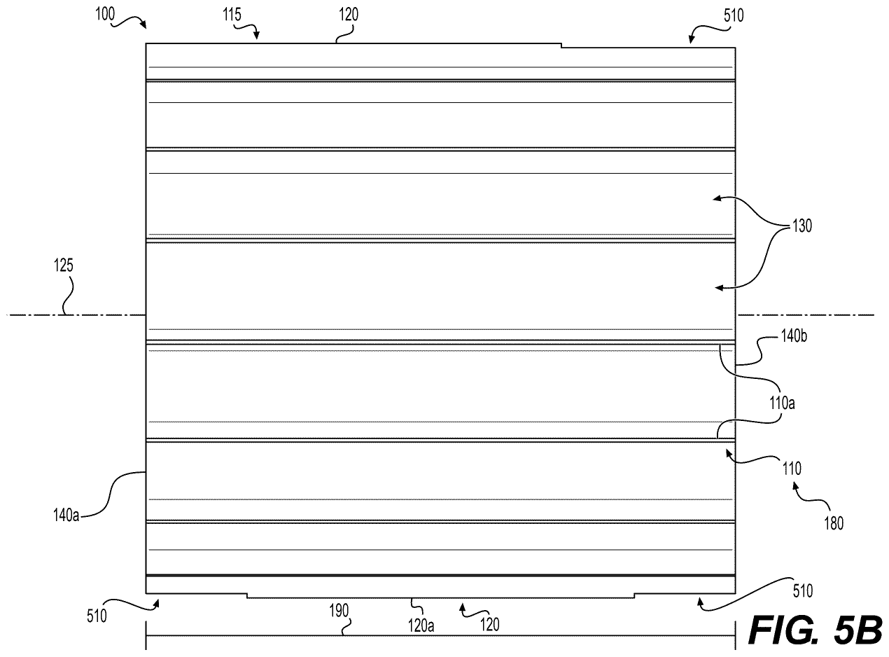

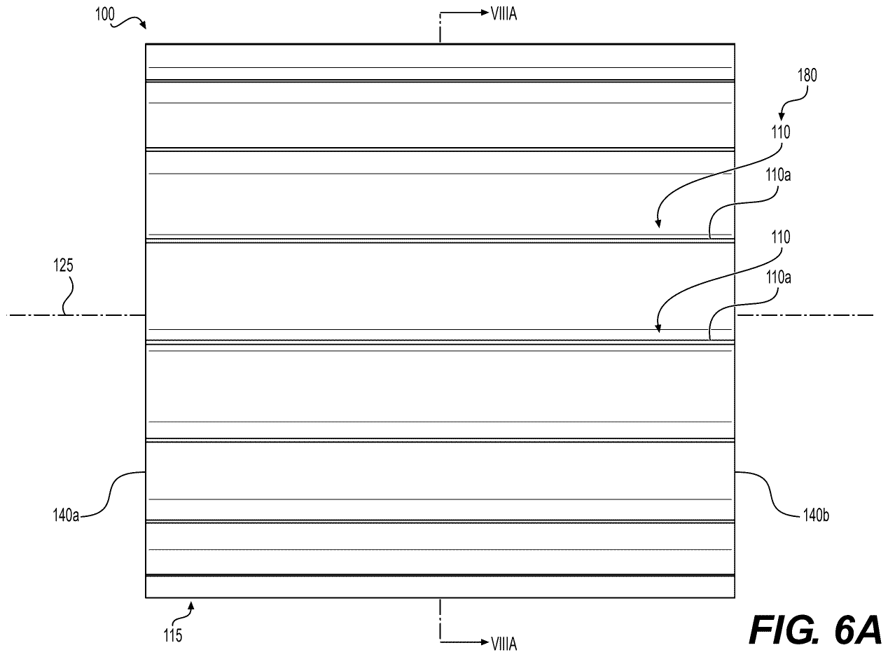

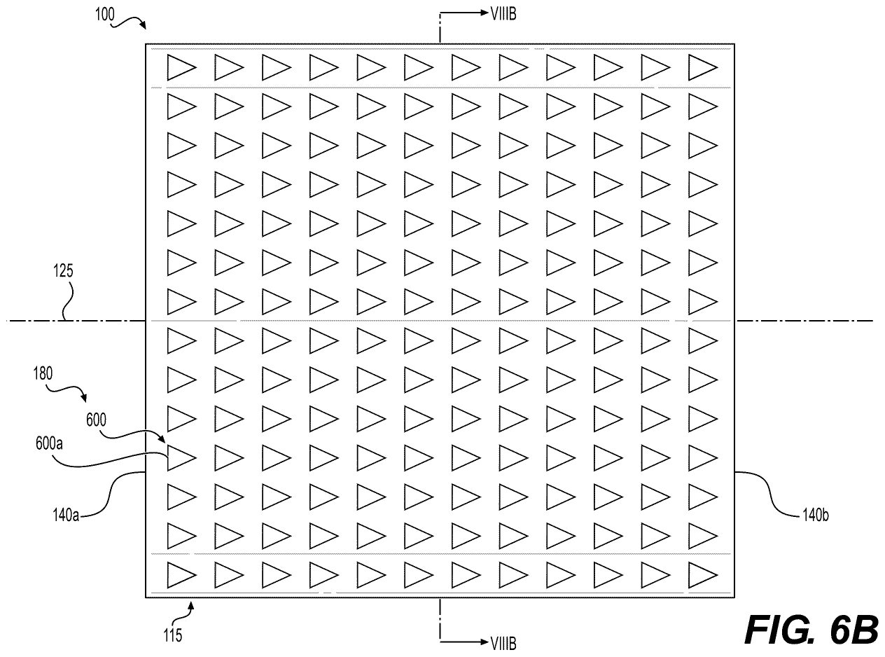

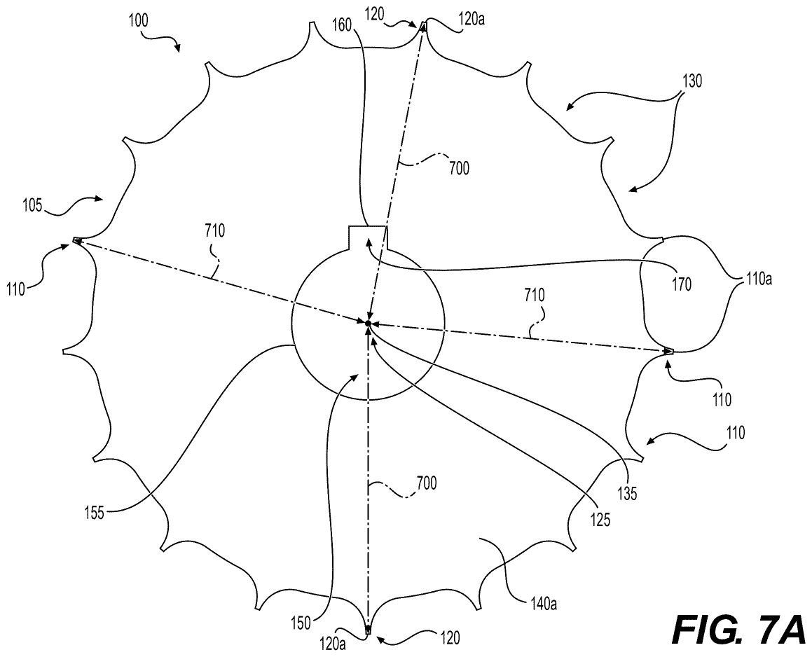

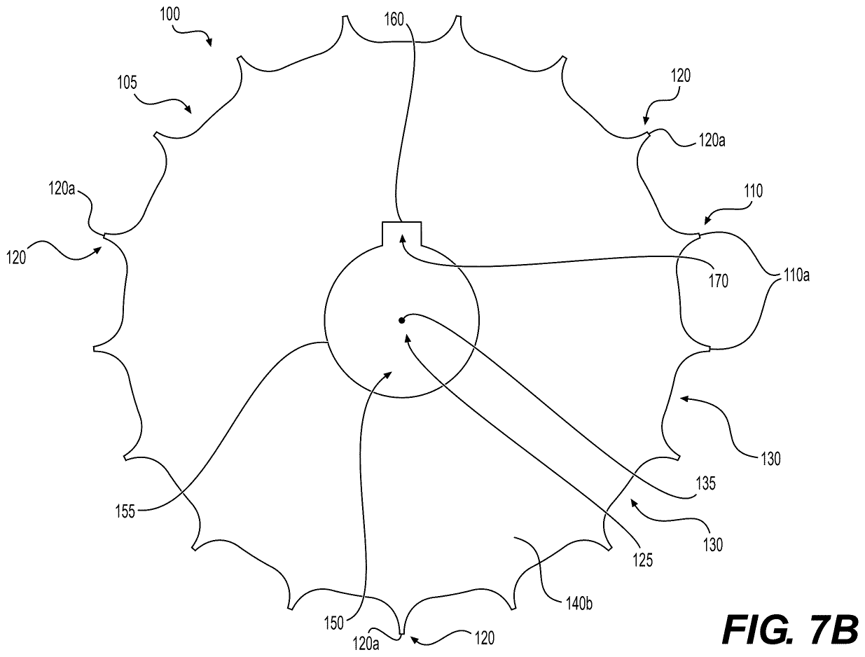

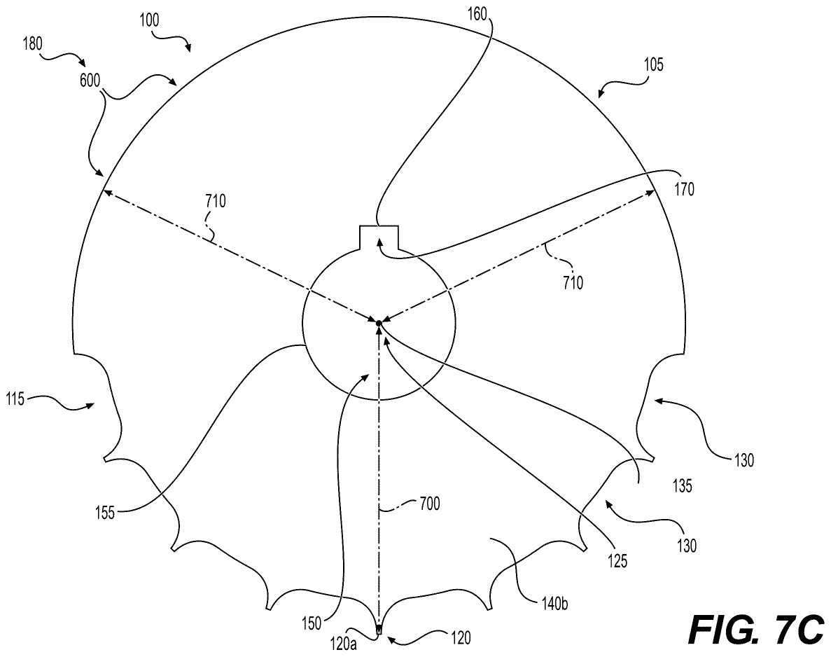

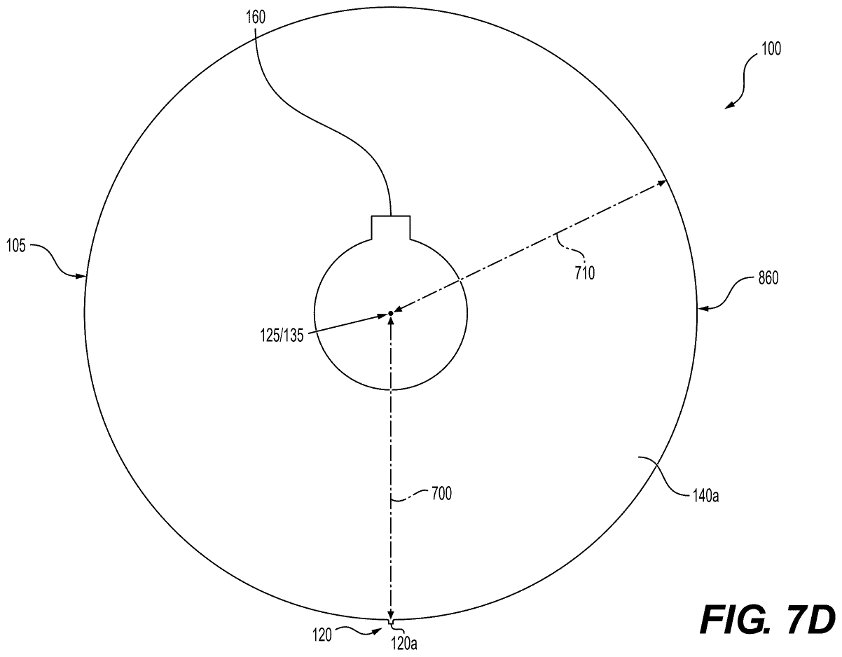

FIGS. 1-4 are illustrations of perspective views of a separator drum 100, in accordance with at least one example embodiment. FIGS. 5A and 5B are an illustrations of side views of the separator drum 100, in accordance with at least one example embodiment. FIGS. 6A and 6B are illustrations of top views of the separator drum 100, in accordance with at least one example embodiment. FIGS. 7A-7C are illustrations of front and back views of the separator drum 100, in accordance with at least one example embodiment. FIG. 7D is an illustration of a cross-sectional view of the separator drum 100 that does not include an embossing design, in accordance with at least one example embodiment.

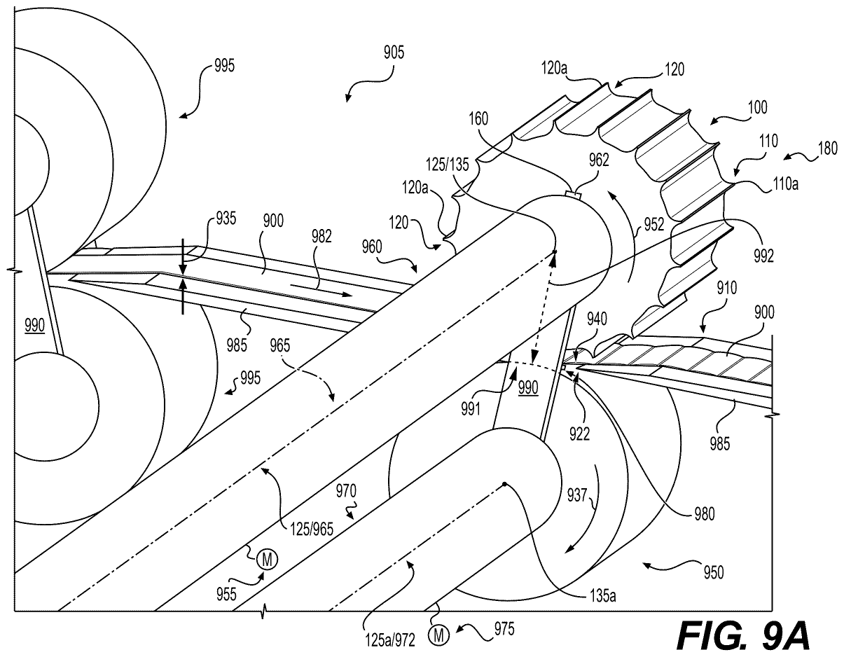

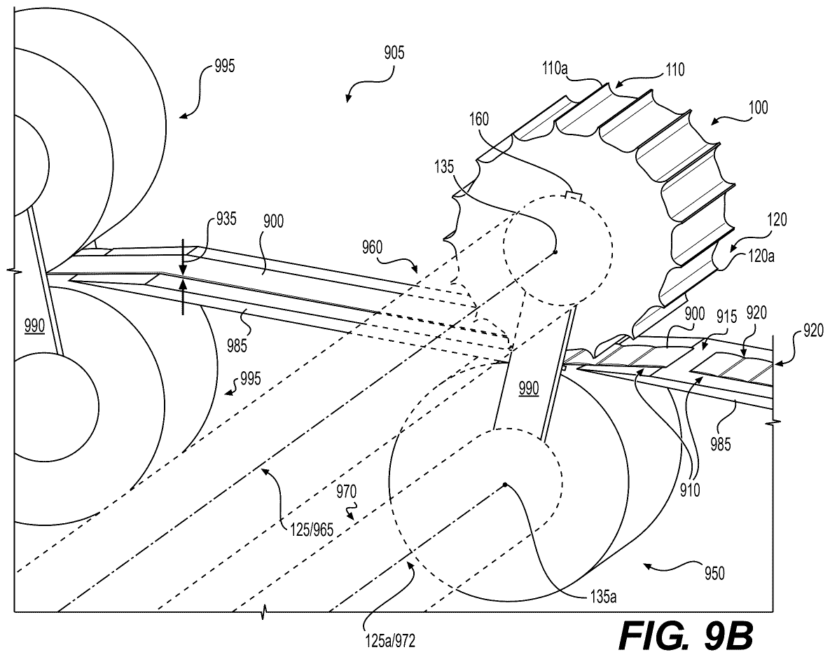

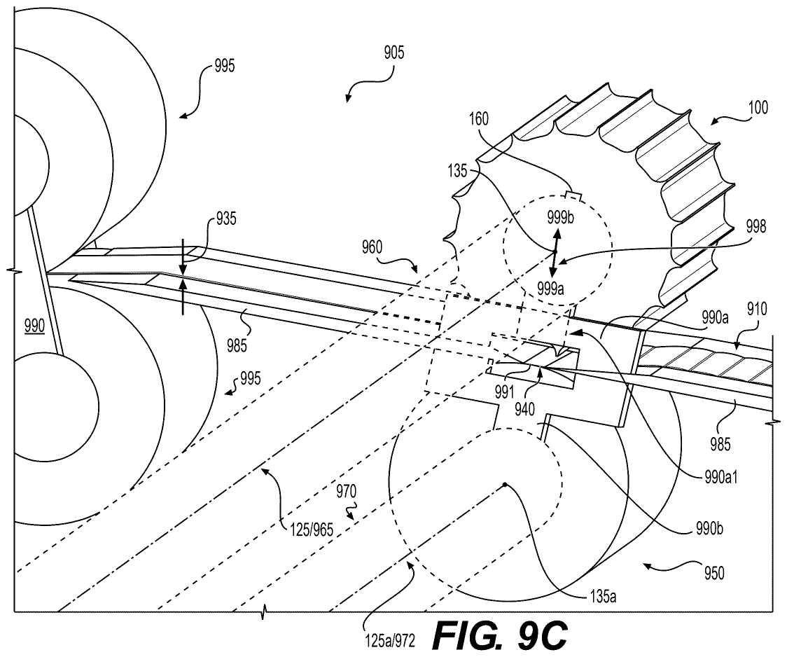

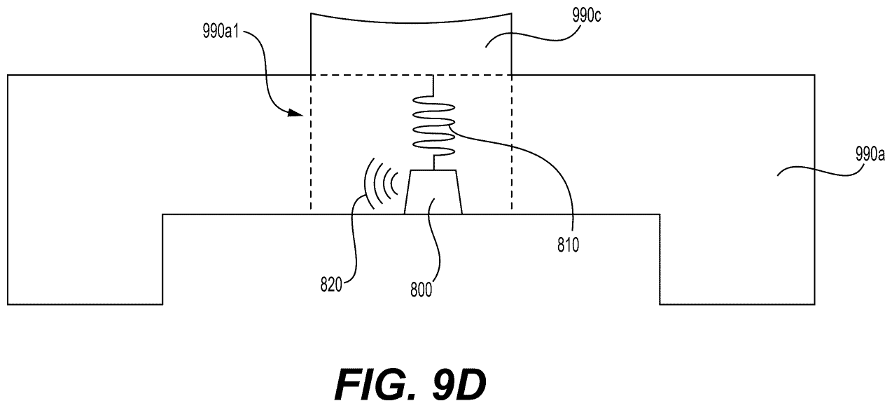

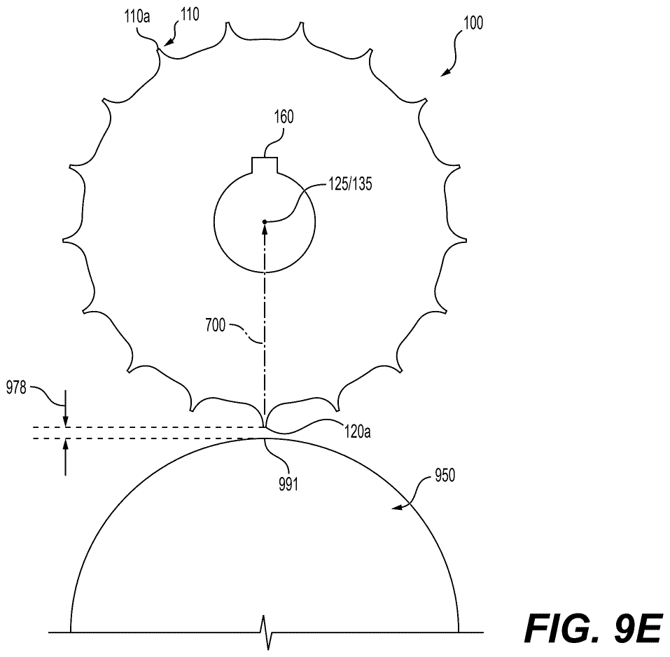

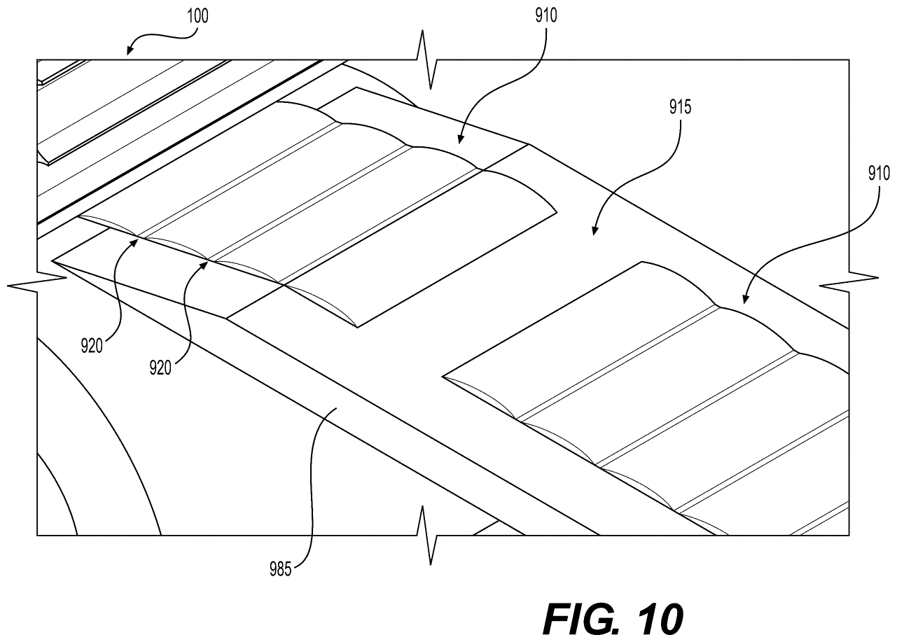

In at least one example embodiment, the separator drum 100 is formed from a major body 105 that is cylindrical in shape. In at least one example embodiment, the separator drum 100 has side surfaces 115 that extend from a first end 140a to a second end 140b of the separator drum 100. In at least one example embodiment, the first end 140a and the second end 140b are flat surfaces that oppose each other on the separator drum 100. In at least one example embodiment, the separator drum 100 can be part of a system 905 (FIG. 9A), where the separator drum 100 is mounted onto a first drive shaft 960 that drives the separator drum 100 to rotate and help process at least one consumer product 910, as described in more detail in at least FIGS. 9A and 9B. In at least one example embodiment, the side surfaces 115 define at least one embossing design 180. In at least one example embodiment, the at least one embossing design 180 can be imprinted onto a material 900 during a manufacturing of the at least one consumer product 910 (see at least FIGS. 9A and 10).

In at least one example embodiment, the at least one embossing design 180 includes ridges 110 that are between grooves 130. In at least one example embodiment, the ridges 110 each define a peak 110a that extends along at least part of a longitudinal length 190 of the separator drum 100 (see at least FIG. 5A), from the first end 140a to the second end 140b. In at least one example embodiment, the peak 110a of the ridges 110 extend along an entirety of the longitudinal length 190 of the separator drum 100, from the first end 140a to the second end 140b. In at least one example embodiment, the ridges 110 are spaced equidistantly around a periphery of the side surfaces 115 (see at least FIG. 7A).

In at least one example embodiment, the major body 105 of the separator drum 100 includes an interior surface 155 that defines an aperture 150 that runs through the center of the major body 105, from the first end 140a to the second end 140b. In at least one example embodiment, the aperture 150 has a vertical cross-sectional shape that is circular (see at least FIG. 7A). In at least one example embodiment, a groove 170 is defined along the interior surface 155 of the major body 105, where the groove 170 is defined along part of a periphery of the aperture 150. In at least one example embodiment, a vertical cross-sectional shape of the groove 170 is rectangular or square, such that the groove 170 appears to be a notch 160 when looking through the aperture 150 from the first end 140a or the second end 140b (see at least FIG. 7A).

In at least one example embodiment, a longitudinal centerline (imaginary line) 125 runs through a center 135 of a vertical cross-section of the separator drum 100, from the first end 140a to the second end 140b (see at least FIGS. 1 and 7A). In at least one example embodiment, the longitudinal centerline 125 runs through the middle of the aperture 150, where the center 135 of the vertical cross-section of the separator drum 100 is also the center 135 of the aperture 150.

In at least one example embodiment, the side surfaces 115 of the separator drum 100 define at least one first ridge 120 that defines at least one first peak 120a. In at least one example embodiment, the at least one first peak 120a extends along at least part of the longitudinal length 190 of the separator drum 100 (FIG. 5A), from the first end 140a to the second end 140b. In at least one example embodiment, the at least one first peak 120a extends along an entirety of the longitudinal length 190 of the separator drum 100, from the first end 140a to the second end 140b. In at least one example embodiment, the at least one first peak 120a of the at least one first ridge 120 is radially extended further from the longitudinal centerline 125 of the separator drum 100, relative to a remainder of the side surfaces 115 (see a further discussion in at least FIG. 7A). In at least one example embodiment, the at least one first peak 120a is a sharp distal edge of the at least one first ridge 120, where the sharp distal edge can cut and separate the material 900 during a manufacturing of the at least one consumer product 910 (see at least FIG. 9A), as described herein in more detail.

In at least one example embodiment, and as shown in FIG. 5B, the at least one first peak 120a of the at least one first ridge 120 may include notches 510, or the at least one first peak 120a may otherwise not extend fully to the first end 140a and/or the second end 140b of the major body 105. In at least one example embodiment, each of the at least one first peak 120a may include more than one of the notches 510. In at least one example embodiment, and as shown in FIGS. 5B and 7A, the at least one first ridge 120 includes two or more first ridges 120, where each of the first ridges 120 includes the at least one first peak 120a.

In at least one example embodiment, and as shown in at least FIGS. 6B and 7C, the at least one embossing design 180 includes an embossing pattern 600 with a raised surface 600a that is a repeating pattern. In at least one example embodiment, the embossing pattern 600 can be any pattern, and can include for instance a trademark, a shape, a symbol, letters, indicia, or combinations thereof. In at least one example embodiment, a majority of the side surfaces 115 define the embossing pattern 600 (FIG. 6B). In at least one example embodiment, a portion or half of the side surfaces 115 define the embossing pattern 600 (see FIG. 7C, in particular).

In at least one example embodiment, the at least one first peak 120a of the at least one first ridge 120 is a first radial distance 700 from the longitudinal centerline 125 of the major body 105 of the separator drum 100, for each vertical cross-section of the major body 105 from the first end 140a to the second end 140b (see at least FIGS. 7A and 7C). In at least one example embodiment, the at least one first ridge 120 includes two or more first ridges 120, where each of the first ridges 120 includes the at least one first peak 120a, and each of the at least one first peak 120a is the first radial distance 700 (a same radial distance) from the longitudinal centerline 125. In at least one example embodiment, the first radial distance 700 is a maximal radial distance from the longitudinal centerline 125, relative to a remainder of the outer surface of the major body 105, for each vertical cross-section of the major body 105, from the first end 140a to the second end 140b (see FIGS. 7A and 7C).

In at least one example embodiment, the ridges 110 and/or the at least one embossing design 180 are less than or equal to a second radial distance 710 from the longitudinal centerline 125, for each vertical cross-section of the major body 105 from the first end 140a to the second end 140b (see at least FIGS. 7A and 7C). In at least one example embodiment, the first radial distance 700 is longer than the second radial distance 710.

In at least one example embodiment, a difference in length between the first radial distance 700 and the second radial distance 710 ensures that the at least one first peak 120a provides a cutting/separating capability for the at least one first peak 120a. In at least one example embodiment, and as described herein in more detail herein, the first radial distance 700 and the second radial distance 710 are determined to ensure that the at least one first peak 120a can separate (cut) the material 900 (as shown in at least FIG. 9B), whereas a reminder of the side surfaces 115 of the separator drum 100 is not able to separate (cut) the material 900. In at least one example embodiment, depending on a length of the second radial distance 710 associated with the at least one embossing design 180, and depending on a consistency of the material 900, at least part of the at least one embossing design 180 can emboss, imprint and/or score the material 900.

In at least one example embodiment, and as shown in FIG. 7D, the separator drum 100 includes the at least one first peak 120a that is the first radial distance 700 from the longitudinal centerline 125, where a remainder of the outer surfaces of the major body 105 includes a smooth surface 860 that is the second radial distance 710 from the longitudinal centerline 125. That is to say, in at least one example embodiment, the separator drum 100 does not include an embossing design, and the separator drum 100 is instead only used to cut and separate the material 900 (FIG. 9A), but not emboss the material 900.

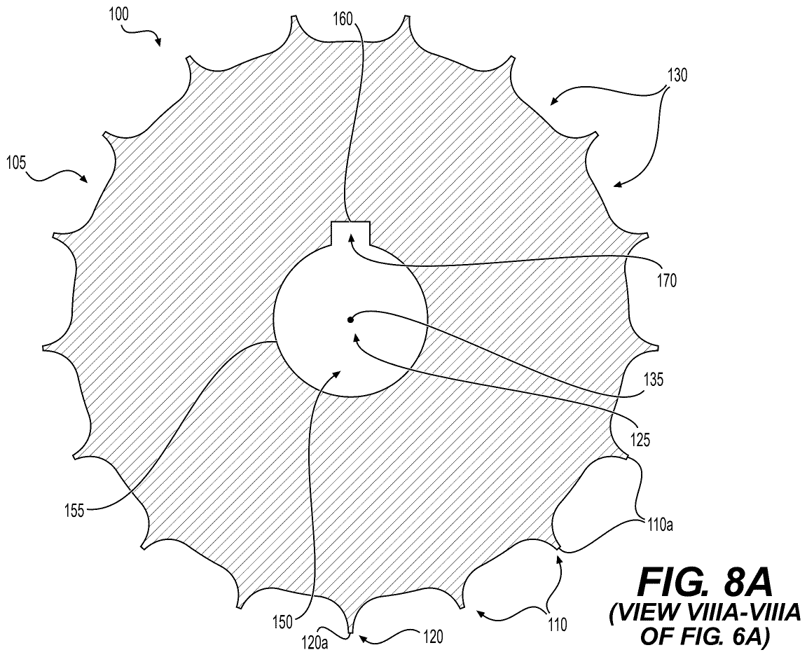

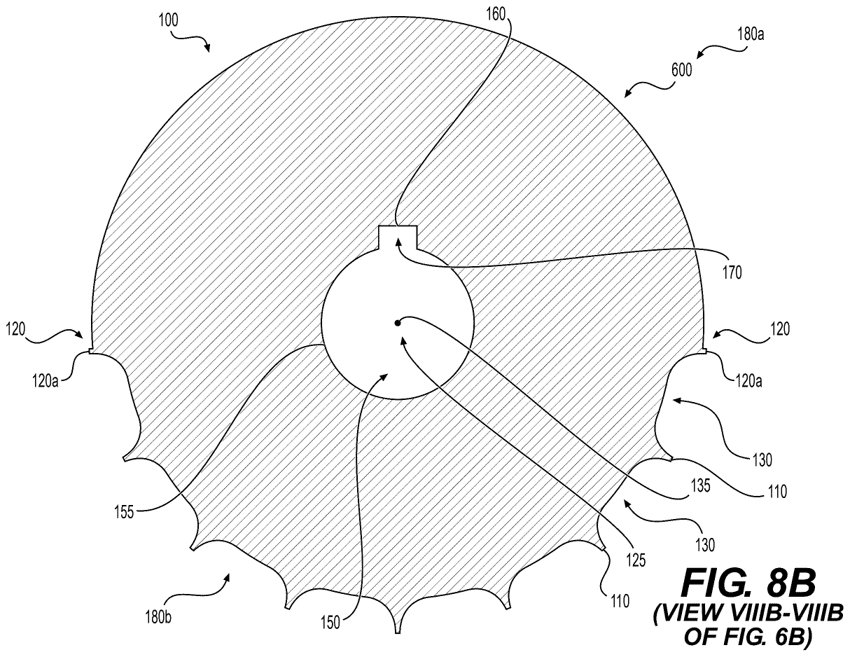

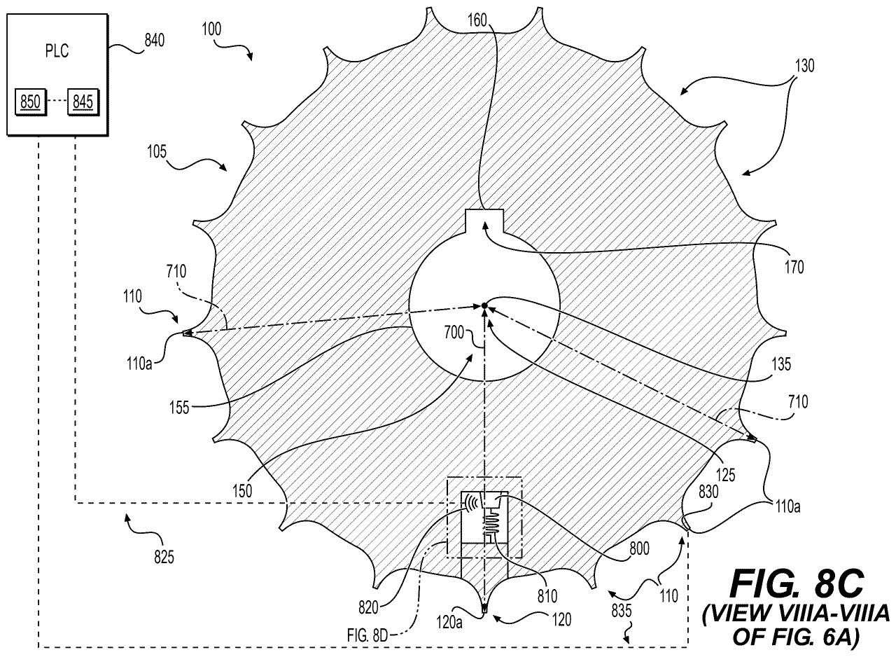

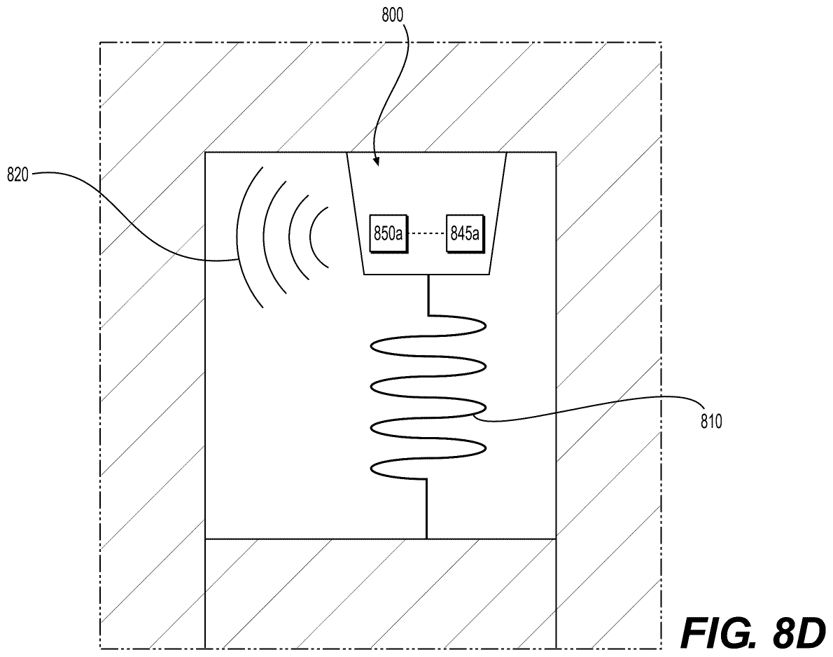

FIGS. 8A-8C are illustrations of cross-sectional views (View VIIIA-VIIIA of FIG. 6 and VIIIB-VIIIB of FIG. 6) of the separator drum 100, in accordance with at least one example embodiment. FIG. 8D is an illustration of an exploded view of a portion of FIG. 8C, in accordance with at least one example embodiment.

In at least one example embodiment, and as shown in at least FIG. 8A, the major body 105 of the separator drum 100 is a substantially solid material, from the first end 140a to the second end 140b, aside from the aperture 150.

In at least one example embodiment, and shown in at least FIG. 8B, the at least one first ridge 120 can be at various locations along a periphery of the separator drum 100. In at least one example embodiment, and as shown in FIG. 8B, the at least one first ridge 120 is at transitions between a first embossing design 180a (including the embossing pattern 600 shown in FIGS. 6B and 7C) and a second embossing design 180b (including the ridges 110 shown in FIG. 7C).

In at least one example embodiment, and as shown in FIG. 8C, the separator drum 100 may include an actuator 800 for extending the at least one first peak 120a, in a radial direction from the longitudinal centerline 125, to the first radial distance 700. In at least one example embodiment, the actuator 800 has a capability of retracting the at least one first peak 120a, at least temporarily, such that the at least one first peak 120a is at or below the second radial distance 710 for at least some revolutions (and/or portions of the revolutions) of the separator drum 100 when the separator drum 100 is being used in the system 905, as explained herein in more detail.

In at least one example embodiment, the actuator 800 includes at least one of a servo motor, a stepper motor, a linear actuator, etc. In at least one example embodiment, the actuator 800 is a hydraulic actuator, a pneumatic actuator, a piezoelectric actuator, a thermal expansion actuator, a magnetic actuator, etc. In at least one example embodiment, the actuator 800 works in conjunction with a spring 810.

In at least one example embodiment, and as shown in FIG. 8D, the actuator 800 includes a controller 845a that is operationally connected to a memory 850a with computer-readable instructions, where the controller 845a reads the computer-readable instructions that are used to control operations of the controller 845a, where some of the operations of the controller 845a are described herein. In at least one example embodiment, the actuator 800 includes a wireless interface 820, allowing the controller 845a to send and receive control/information signals 825 to entities that are external to the actuator 800. In at least one example embodiment, the control/information signals 825 are used to exchange information with a programmable logic controller (PLC) 840, where the controller 845a provides confirmation of a position of the actuator 800 to the PLC 840, and the controller 845a receives commands from the PLC 840, as described herein.

In at least one example embodiment, the PLC 840 also includes a controller 845 that is operationally connected to a memory 850 with computer-readable instructions, where the controller 845 reads the computer-readable instructions that are used to control operations of the controller 845, where some of the operations of the controller 845 are described herein. In at least one example embodiment, the controller 845 of the PLC 840 exchanges the control/information signals 825 with the actuator 800, where some of the control/information signals 825 includes the controller 845 sending commands to the actuator 800 to control at least some of the actions and/or movement of the actuator 800 (the PLC 840 offers a “remote control” of the actuator 800). In at least one example embodiment, the PLC 840 controls the actions of a first motor 955 of the first drive shaft 960 for the separator drum 100, the actions of a second motor 975 of a second drive shaft 970 for a roller 950, as well as other elements of the system 905 (see at least FIG. 9A), to coordinate the actions of the PLC 840 and the actuator 800 with the system 905.

In at least one example embodiment, the actuator 800 extends the at least one first peak 120a to the first radial distance 700 intermittently, such as during a second or a third revolution of the separator drum 100, when the separator drum 100 is installed and is in operational use in the system 905 (see at least FIGS. 9A and 9B). In at least one example embodiment, the actuator 800 extends the at least one first peak 120a to the first radial distance 700 intermittently to reduce an overall size of the separator drum 100, to save on material cost and/or make the separator drum 100 more versatile when used for different services or other systems, or when used in other ways within the system 905.

In at least one example embodiment, the separator drum 100 includes a first proximity switch 830 that may be in communication with the PLC 840 (FIG. 8C). In at least one example embodiment, the first proximity switch 830 may exchange control/information signals 835 with the PLC 840, where at least some of the control/information signals 835 notify the PLC 840 when the first proximity switch 830 is within physical proximity to a second proximity switch 980 that is embedded in or near at least one conveyor 985, or near other structure within the system 905 (FIG. 9A). In at least one example embodiment, the control/information signals 835 notify the PLC 840 that the first proximity switch 830 is near an upper-most surface 991 of the roller 950, where the controller 845 of the PLC 840 then sends commands to the actuator 800 of the separator drum 100 to extend the at least one first peak 120a to the first radial distance 700.

FIGS. 9A-9C are illustrations of perspective views of a system 905, in accordance with at least one example embodiment. FIG. 9D is an illustration of a strut, in accordance with at least one example embodiment. FIG. 9E is an illustration of the separator drum 100 interfacing with a roller 950, in accordance with at least one example embodiment.

In at least one example embodiment, the system 905 includes the separator drum 100, and other elements that may be used to process the material 900 into the at least one consumer product 910. In at least one example embodiment, the system 905 includes the roller 950, where the separator drum 100 is positioned above the roller (lower roller) 950, so that the separator drum 100 and the roller 950 can interface with each other at a break point 940 of the at least one conveyor 985. In at least one example embodiment, during an operation of the system 905, the separator drum 100 and the roller 950 receive the material 900 that is formed into a thin band (FIG. 9A) and is moving in a first direction 982 along the at least one conveyor 985, where the separator drum 100 and the roller 950 rotate in opposite directions to assist the material 900 in continuing to move in the first direction 982 (FIG. 9A). That is to say, in at least one example embodiment, during an operation of the system 905, the separator drum 100 rotates in a first rotational direction 952 while the roller 950 rotates in a second rotational direction 937 to continue to move the material 900 in the first direction 982. In at least one example embodiment, at the break point 940 of the at least one conveyor 985, the material 900 directly contacts and lies on the upper-most surface 991 of the roller 950, as the separator drum 100 helps process the material 900 (see FIGS. 9A and 9C), prior to the material 900 passing over a sharp edge 922 of the at least one conveyor 985 and back onto the at least one conveyor 985.

In at least one example embodiment, the separator drum 100 and the roller 950 are in working proximity to each other at the break point 940, where the at least one first peak 120a contacts, or comes infinitesimally close to contacting, the upper-most surface 991 of the roller 950, due to the at least one first peak 120a being at the first radial distance 700 from the longitudinal centerline 125 (see at least FIG. 7A). In at least one example embodiment, the first radial distance 700 spans a distance (physical separation) 992, or nearly spans the distance 992, between the longitudinal centerline 125 of the separator drum 100 and an upper-most surface 991 of the roller 950 (see FIG. 9A), such that the at least one first peak 120a is within a “separating proximity” 978 of the upper-most surface 991 of the roller 950 (see FIG. 9E), when the at least one first peak 120a is closest to the roller 950 as the separator drum 100 rotates during an operation of the system 905. In at least one example embodiment, and as explained in further detail herein, the first radial distance 700 is equal to the distance 992, or the first radial distance 700 is slightly less than the distance 992.

In at least one example embodiment, and as shown in FIG. 9A, a portion of the first drive shaft 960 fits into the aperture 150 (FIG. 1) of the separator drum 100, where a notch 962 on the first drive shaft 960 interlocks with the groove 170 of the separator drum 100 (see FIGS. 1 and 9A). In at least one example embodiment, a longitudinal centerline 965 of the first drive shaft 960 is collinear with the longitudinal centerline 125 of the separator drum 100. In at least one example embodiment, a longitudinal centerline 972 of the second drive shaft 970 is likewise collinear with a longitudinal centerline 125a and a center 135a of the roller 950. In at least one example embodiment, struts 990 are used to help support the separator drum 100, the roller 950 and the drive shafts 960/970, where the struts 990 can control a physical distance between the separator drum 100 and the roller 950, as described below in more detail.

In at least one example embodiment, the system 905 includes pairs of other rollers 995. In at least one example embodiment, the pairs of other rollers 995 are used to smooth and/or flatten the material 900 into the thin band of the material 900, either upstream or downstream of the separator drum 100. In at least one example embodiment, the pairs of other rollers 995 are upstream of the separator drum 100 (as shown in FIG. 9A), where the other rollers 995 are used to press the material 900 to a thickness 935 that facilitates the embossing and separating of the material 900 via the separator drum 100. In at least one example embodiment, a rotation of the pairs of other rollers 995 can be powered by motors (not shown), where a rotational speed of the pairs of other rollers can also be controlled by the PLC 840 (FIG. 8C).

In at least one example embodiment, the system 905 includes the at least one conveyor 985 at various locations within the system 905. In at least one example embodiment, the at least one conveyor 985 can be a stationary ramp, where mobility of the material 900 within the system 905 is caused by a rotational movement of the separator drum 100 and/or the rollers 950/995. In at least one example embodiment, the at least one conveyor 985 may optionally include a motorized (continuous) belt, or other means of mobilizing the material 900, aside from a rotation of the separator drum 100 and/or the rollers 950/995 also moving the material 900 through the system 905. In at least one example embodiment, the system 905 does not include the pairs of other rollers 995 and the roller 950, and instead the at least one conveyor 985 moves the material 900 in the first direction 982 by a continuous belt on the at least one conveyor 985 (not shown), where the separator drum 100 interacts with the material 900 while the material 900 is directly on the at least one conveyor 985.

In at least one example embodiment, the first radial distance 700 of the at least one first peak 120a is calibrated to be long enough to separate (cut) the material 900. In at least one example embodiment, the at least one embossing design 180 is at or below the second radial distance 710 (see at least FIG. 7A), and therefore the at least one embossing design 180 is unable to separate or cut the material 900 and instead is able to emboss or score the material 900.

In at least one example embodiment, the material 900 includes an insoluble gum base, and the at least one consumer product 910 includes chewing gum. In at least one example embodiment, the material 900 includes resins, humectants, elastomers, emulsifiers, fillers, waxes, antioxidants, and softeners, including sweeteners, flavoring agents, and combinations thereof. In at least one example embodiment, the material 900 includes other well-known ingredients for making chewing gum. In at least one example embodiment, the at least one consumer product 910 includes oral products aside from, or including, chewing gum. In at least one example embodiment, the material 900 can include any material used to form consumer products, where the material 900 is malleable and able to be cut/separated.

In at least one example embodiment, the at least one consumer product 910 is chewing gum, and the material 900 includes a gum base polymer, an oil, nicotine or a nicotine derivative, and a buffer system. In at least one example embodiment, the gum base polymer includes polyvinyl acetate (PVA) and the oil includes a triglyceride. In at least one example embodiment, the at least one consumer product 910 is a controlled-release nicotine chewing gum. In at least one example embodiment, the at least one consumer product 910 is made by a process described in U.S. application Ser. No. 18/778,364, filed Jul. 19, 2024, the entire disclosure of which is incorporated herein by reference in its entirety.

In at least one example embodiment, the thickness 935 of the material 900 and a consistency of the material 900 can change over time, either due to a change in a type of the material 900 used within the system 905, and/or due to “other ambient factors.” In at least one example embodiment, the “other ambient factors” can include changes in an ambient temperature, humidity, exposure to sunlight and/or bright light, etc. In at least one example embodiment, in the event the consistency or the thickness 930 of the material 900 changes, a rotational speed of the separator drum 100 and the rollers 950/995, and/or a re-calibration of the first radial distance 700 and/or the second radial distance 710 (FIG. 7A) may be required. In at least one example embodiment, a re-calibration of the first radial distance 700 and/or the second radial distance 710 may need to be accomplished on a regular basis that may be daily, or throughout a day, and may potentially necessitate a substitution of the separator drum 100 and/or the roller 950/995 to account for the type of the material 900 and/or account for the “other ambient factors.” In at least one example embodiment, multiple sets of the separator drum 100 and/or the roller 950/995 of various sizes may help make larger adjustments, aside from adjustments due to changes in the rotational speed and/or adjustments to the first radial distance 700. In at least one example embodiment, a position of the longitudinal centerline 125 of the separator drum 100 is adjustable (as described herein), so as to ensure that the at least one first peak 120a is within the “separating proximity” 978 (FIG. 9E) that accounts for the consistency of the material 900 and the “other ambient factors.”

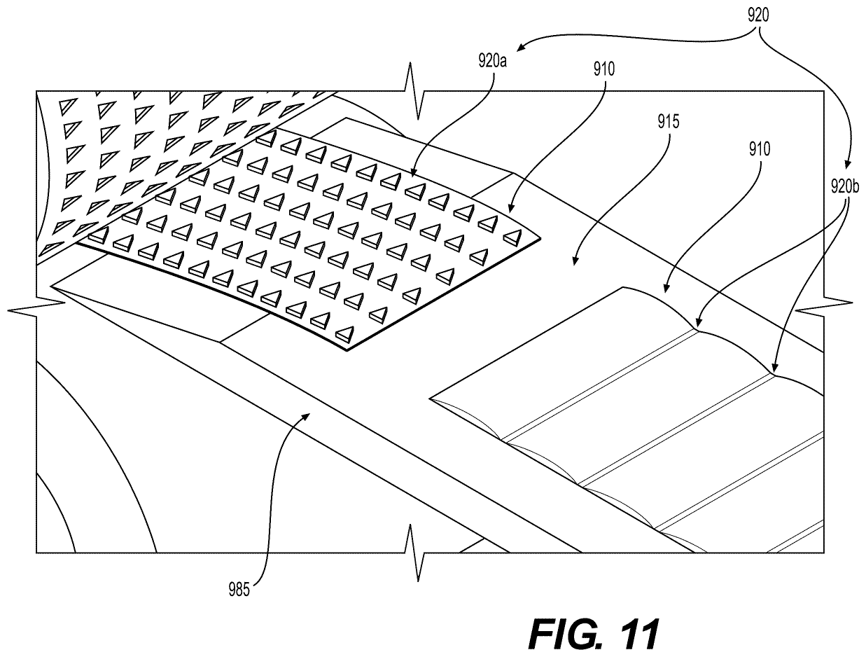

In at least one example embodiment, if the distance 992 between the longitudinal centerline 125 of the separator drum 100 and the upper-most surface 991 of the roller 950 is too small, the at least one embossing design 180 can damage, tear, and/or separate the material 900 in an undesired way. And, if the distance 992 is too large, the at least one embossing design 180 may fail to imprint at least one embossed design 920 (see at least FIGS. 9A and 11) onto the material 900 while the at least one first peak 120a may fail to cause a separation (cut) 915 of the material 900 (see FIG. 9B). In at least one example embodiment, the distance 992 can be adjusted using the struts 990 (see at least FIG. 9A), to bring the separator drum 100 closer or further apart from the roller 950 to ensure that the at least one first peak 120a of the separator drum 100 is within the “separating proximity” 978 that is able to cause a separation (cut) 915 of the material (as shown in FIG. 9B) for a type, a consistency and a thickness of the material 900, while allowing the at least one embossing design 180 to create the at least one embossed design 920 onto the material 900 without separating/cutting the material 900 (see at least FIGS. 9A and 11).

In at least one example embodiment, the material 900 is the gum base, and the thickness 935 is in a range of about 1 mm to 15 mm, or about 2 mm to 12 mm, or about 4 mm to 10 mm, or about 8 mm. In at least one example embodiment, the separating proximity 978 (distance between a distal end of the at least one first 120a and the upper-most surface 991 of the roller 950) is in a range of about 0 mm to 2 mm, or about 0.2 mm to 0.8 mm, or about 0.4 mm to 0.6 mm, or about 0.5 mm. In at least one example embodiment, the separating proximity 978 is 4/1000^{th} of an inch (0.01 mm). In at least one example embodiment, and as explained herein, the thickness 935 and the separating proximity 978 may change depending on the consistency of the gum base and the “other ambient factors.”

In at least one example embodiment, the separator drum 100 and the roller 950 are connected to the at least one conveyor 985 via a first strut 990a and a second strut 990b, respectively (see FIG. 9C). In at least one example embodiment, the first strut 990a includes an actuation section 990a1 that includes the actuator 800 (see FIG. 9D), where the actuator 800 controls fine movements (up and down) of the first drive shaft 960 and/or the separator drum 100. In at least one example embodiment, the actuator 800 extends and retracts a portion 99c of the first strut 990a, to move the longitudinal centerline 125 of the first drive shaft 960 and/or the separator drum 100 along a direction of movement 998 between a first position 999a and a second position 999b (FIG. 9C). In at least one example embodiment, the first position 999a causes the longitudinal centerline 125 to be closer to the roller 950, and the second position 999b causes the longitudinal centerline 125 to be further from the roller 950.

In at least one example embodiment, the PLC 840 (FIG. 8C) communicates with the actuator 800 of the first strut 990a via the wireless interface 820, or by other means, to provide servo control for the movement of the longitudinal centerline 125 between the first position 999a and the second position 999b. In at least one example embodiment, the PLC 840 maintains the longitudinal centerline 125 of the separator drum 100 to be in the second position 999b for durations of time, where the PLC 840 controls the actuator 800 to momentarily move (deflect) the longitudinal centerline 125 into the first position 999a (deflects the separator drum 100 downward), when the at least one first peak 120a is in a downward position and is engaging the material 900 to separate the material 900.

In at least an alternative example embodiment, the separator drum 100 is devoid of the at least one first ridge 120, and instead includes only the at least one embossing design 180. In at least this alternative embodiment, the PLC 840 maintains the longitudinal centerline 125 of the separator drum 100 to be in the second position 999b, and momentarily moves the longitudinal centerline 125 to the first position 999a (momentarily deflects the separator drum 100 downward), when one of the peaks 110a of the separator drum 100 are in a downward position and are engaging the material 900 to separate the material 900. That is to say, in at least this alternative embodiment, the separation 915 (FIG. 9B) of the material 900 is caused by the PLC 840 deflecting the separator drum 100 downward so the longitudinal centerline 125 is in the first position 999a to cause at least a portion of the at least one embossing design 180 to be within the separating proximity 978 to create the separation 915.

FIG. 10 is an illustration of consumer products being processed by the separator drum 100, in accordance with at least one example embodiment.

In at least one example embodiment, and as shown in FIG. 10, the at least one consumer product 910 includes the at least one embossed design 920 that is imprinted by the at least one embossing design 180 of the separator drum 100, where the at least one consumer product 910 includes the separation 915 at desired locations that is caused by the at least one first peak 120a of the separator drum 100 that is within the separating proximity 978 to the upper-most surface 991 of the roller 950 (FIGS. 9A and 9E).

FIG. 11 is an illustration of a perspective view of a consumer product that is being processed by the separator drum 100, in accordance with at least one example embodiment.

In at least one example embodiment, the at least one embossed design 920 includes a first embossed design 920a and a second embossed design 920b made from the first embossing design 180a (FIGS. 6B and 8B) and the second embossing design 180b (FIG. 8B), respectively.

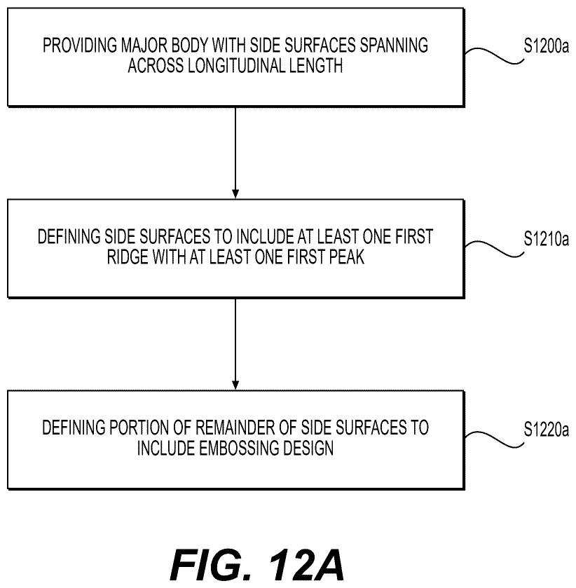

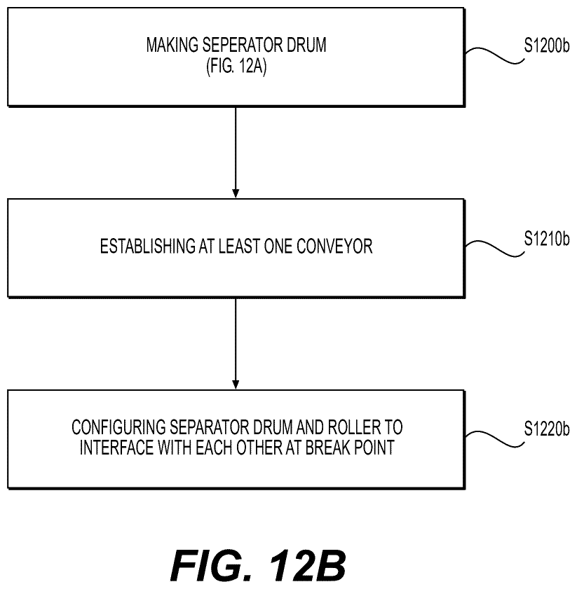

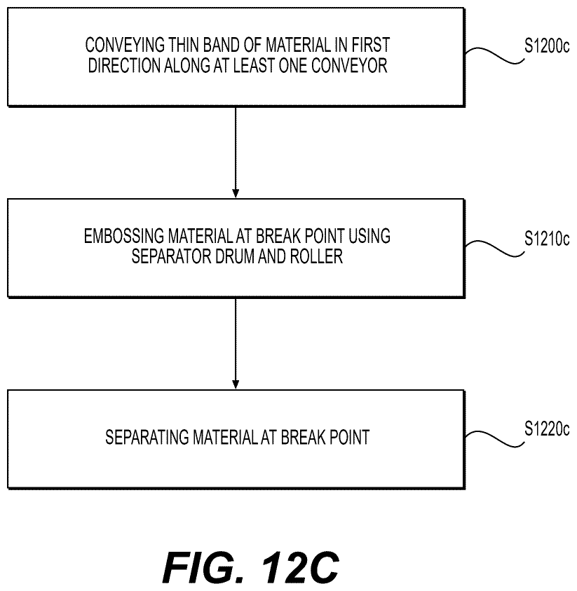

FIG. 12A is an illustration of method steps for a method of making the separator drum 100, in accordance with at least one example embodiment.

In at least one example embodiment, and as shown in step S1200a, the method includes providing the major body 105 (FIG. 1) with the side surfaces 115 that span across the longitudinal length 190 of the major body 105 (FIG. 5A), from the first end 140a to the second end 140b of the major body 105. In at least one example embodiment, the longitudinal centerline 125 of the major body 105 runs through the center 135 of the vertical cross-section of the major body 105 from the first end 140a to the second end 140b (see at least FIGS. 1 and 7A).

In at least one example embodiment, and as shown in step S1210a, the method further includes defining the side surfaces 115 to include the at least the one first ridge 120 with the at least one first peak 120a (see at least FIG. 7A) that extend along at least part of the longitudinal length 190 of the major body 105.

In at least one example embodiment, and as shown in step S1220a, the method further includes defining a portion of a remainder of the side surfaces 115 to include the at least one embossing design 180 (see at least FIG. 1A). In at least one example embodiment, the at least one first peak 120a extends to, or is configured to extend to, the first radial distance 700, (see at least FIGS. 7A and 8C), where the first radial distance 700 is larger than a respective radial distance for an outer surface of a remainder of the side surfaces 115.

FIG. 12B is an illustration of method steps for a method of making the system 905, in accordance with at least one example embodiment.

In at least one example embodiment, and as shown in step S1200b, the method includes making the separator drum 100 (see at least FIG. 12A).

In at least one example embodiment, and as shown in step S1210b, the method further includes establishing at least one conveyor 985 (see at least FIG. 9A), where the at least one conveyor conveys the material 900 in the first direction 982.

In at least one example embodiment, and as shown in step S1220a, the method further includes configuring the separator drum 100 and the roller 950 to interface with each other at the break point 940 of the at least one conveyor 985 (see at least FIG. 9A), where the roller 950 and the separator drum 100 are below and above the break point 940. In at least one example embodiment, the separator drum 100 and the roller 950 are further configured to rotate in opposite directions 952/937 (see at least FIG. 9A). In at least one example embodiment, the roller 950 has a smooth outer surface that is able to receive the material 900 and convey the material 900 across the break point 940 and back onto the at least one conveyor 985.

FIG. 12C is an illustration of method steps for a method of using the system 905, in accordance with at least one example embodiment.

In at least one example embodiment, and as shown in step S1200c, the method includes conveying the thin band of the material 900 in the first direction 982 along the at least one conveyor 985 (see at least FIG. 9A).

In at least one example embodiment, and as shown in step S1210c, the method further includes embossing the material 900 at the break point 940 using the separator drum 100 and the roller 950 (see at least FIG. 9A).

In at least one example embodiment, and as shown in step S1220c, the method further includes separating the material 900 at the break point 940 (see at least FIG. 9A), when the at least one first peak 120a is at the separating proximity 978 from the upper-most surface 991 of the roller 950 (see at least FIG. 9E).

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A separator drum, comprising:
a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end,
at least one first portion of the side surfaces defining at least one first ridge with at least one first peak that extends along at least part of the longitudinal length of the major body, at least one second portion of a remainder of the side surfaces, other than the at least one first portion, defining an embossing design,
the at least one first peak extending to, or being configured to extend to, a first radial distance from the longitudinal centerline, the first radial distance being larger than a respective radial distance from the longitudinal centerline for an outer surface of the remainder of the side surfaces.

2. The separator drum of claim 1, wherein the first radial distance is a maximal radial distance from the longitudinal centerline relative to the outer surface of the remainder of the side surfaces.

3. The separator drum of claim 1, wherein the at least one first peak extends continuously along the longitudinal length of the major body from the first end to the second end.

4. The separator drum of claim 1, wherein the at least one first peak is a sharp edge for cutting and separating at least one material used to make at least one consumer product.

5. The separator drum of claim 1, wherein
the major body defines an aperture running through a center of the major body from the first end to the second end of the major body, and
the longitudinal centerline runs through a center of a vertical cross-section of the aperture from the first end to the second end of the major body.

6. The separator drum of claim 1, wherein the embossing design includes ridges that extend along at least part of the longitudinal length of the major body from the first end to the second end.

7. The separator drum of claim 1, wherein
the embossing design includes a repeating pattern, and
the repeating pattern includes raised shapes, symbols, letters, or indicia that are defined by the at least one second portion of the remainder of the side surfaces.

8. The separator drum of claim 1, further comprising:
an actuator embedded within the major body, the actuator being configured to move the at least one first ridge between a first position and a second position in a direction that is radial to the longitudinal centerline, and
the first position extends the at least one first peak to the first radial distance and the second position retracts the at least one first peak to be a second radial distance from the longitudinal centerline, the first radial distance being larger than the second radial distance.

9. A system, comprising:
at least one conveyor configured to convey a material in a first direction; and
a separator drum and a roller that interface with each other at a break point of the at least one conveyor, the roller and the separator drum being respectively below and above the break point, the roller having a smooth outer surface that is able to receive a first portion of the material and continue to convey the first portion across the break point and back onto the at least one conveyor,
the separator drum including
a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end,
at least one first portion of the side surfaces defining at least one first ridge with at least one first peak that extends along at least part of the longitudinal length of the major body, at least one second portion of a remainder of the side surfaces, other than the at least one first portion, defining an embossing design,
the at least one first peak extending to, or being configured to extend to, a first radial distance from the longitudinal centerline, the first radial distance being larger than a respective radial distance from the longitudinal centerline for an outer surface of the remainder of the side surfaces.

10. The system of claim 9, wherein the outer surface of the remainder of the side surfaces of the separator drum is less than or equal to a second radial distance from the longitudinal centerline, the first radial distance being larger than the second radial distance.

11. The system of claim 9, wherein the at least one first peak of the separator drum extends continuously along the longitudinal length of the major body from the first end to the second end.

12. The system of claim 10, wherein the at least one first peak includes a sharp distal edge for cutting and separating the first portion of the material that is on the outer surface of the roller, when the at least one first peak is within a separating proximity of an upper-most surface of the roller.

13. The system of claim 12, wherein
the material includes an insoluble gum base for making chewing gum, and
the insoluble gum base is conveyed along the at least one conveyor as a thin band of the insoluble gum base.

14. The system of claim 9, wherein
the major body defines an aperture running through a center of the major body from the first end to the second end of the major body, and
the longitudinal centerline runs through a center of a vertical cross-section of the aperture from the first end to the second end of the major body.

15. The system of claim 14, wherein the aperture has a substantially circular vertical cross-section from the first end to the second end of the major body, and a groove is defined along a portion of a periphery of the aperture from the first end to the second end.

16. The system of claim 15, further comprising:
a drive shaft, an end of the drive shaft being configured to fit within the aperture, a notch of the drive shaft being configured to engage and fit within the groove, and
at least one motor, the at least one motor being configured to impart a rotational force on the drive shaft to rotate the separator drum.

17. The system of claim 9, wherein
the embossing design of the separator drum include a repeating pattern, and
the repeating pattern includes raised shapes, symbols, letters, or indicia that are defined by the at least one second portion of the remainder of the side surfaces.

18. The system of claim 9, further comprising:
an actuator embedded within the major body, the actuator being configured to move the at least one first ridge between a first position and a second position in a direction that is radial to the longitudinal centerline, and
the first position extends the at least one first peak to the first radial distance and the second position retracts the at least one first peak to be a second radial distance from the longitudinal centerline, the first radial distance being larger than the second radial distance.

19. The system of claim 18, further comprising:
a programmable logic controller configured to communicate with the actuator, the actuator including a controller and a wireless interface, and the controller is configured to send and receive control and information signals via the wireless interface to respectively provide confirmation to the programmable logic controller that the at least one first ridge is in the first position or the second position and receive commands from the programmable logic controller controls at least some actions of the actuator; a first proximity switch on the major body and near the at least one first ridge; and
a second proximity switch near at least a portion of the break point of the at least one conveyor, the first proximity switch and the second proximity switch being operationally connected to the programmable logic controller, the actuator being operationally connected to the programmable logic controller in order to move the at least one first ridge to the first position when the first proximity switch and the second proximity switch are proximally close to each other.
A method of using a system, comprising:
conveying a thin band of material in a first direction along at least one conveyor;
embossing at least one first portion of the thin band of material at a break point of the at least one conveyor using a separator drum with an embossing design that interfaces with a roller, the roller and the separator drum being respectively below and above the break point, the separator drum and the roller being configured to rotate in opposite directions, the roller having a smooth outer surface that is able to receive the at least one first portion of the thin band of material and continue to convey the at least one first portion across the break point and back onto the at least one conveyor; and
separating part of the at least one first portion using at least one first peak when the at least one first peak is at a separating proximity from an upper-most surface of the roller,
the separator drum including
a major body, the major body being cylindrical in shape with a first end and a second end, the major body having side surfaces that span across a longitudinal length of the major body between the first end and the second end, a longitudinal centerline of the major body running through a center of a vertical cross-section of the major body from the first end to the second end,
at least one first portion of the side surfaces defining at least one first ridge with the at least one first peak that extends along at least part of a longitudinal length of the major body, at least one second portion of a remainder of the side surfaces, other than the at least one first portion, defining the embossing design,
the at least one first peak extending to, or being configured to extend to, a first radial distance from the longitudinal centerline, the first radial distance being larger than a respective radial distance from the longitudinal centerline for an outer surface of the remainder of the side surfaces.
